(19) United States
(12) Patent Application Publication
(10) Pub. No.: US 2023/0093303 A1
(43) Pub. Date: Mar. 23, 2023

(54) METHOD FOR ADAPTING A COMPONENT DESCRIPTION OF A WORKPIECE TO BE PRODUCED WITH AMORPHOUS PROPERTIES

(71) Applicant: Heraeus Amloy Technologies GmbH, Hanau (DE)

(72) Inventors: Hans Jürgen WACHTER, Karlstein (DE); Eugen MILKE, Karlstein (DE); Hamed SHAKUR SHAHABI, Karlstein (DE); Florian THEISEN, Hanau (DE); Michael KLOSCH-TRAGESER, Freigericht (DE)

(21) Appl. No.: 17/905,030

(22) PCT Filed: Feb. 17, 2022
(86) PCT No.: PCT/EP2021/053872

§ 371 Date: Aug. 25, 2022

(30) Foreign Application Priority Data
Feb. 25, 2020 (EP) 20159308.4

(51) Int. Cl. G05B 19/4155; B22D 17/04; B22D 17/32

(52) U.S. Cl. CPC G05B 19/4155; B22D 17/04; B22D 17/32; G05B 2219/45244

(57) ABSTRACT

Amorphous metals are a new class of materials in which advantageous physical properties can be achieved. Amorphous metals require rapid cooling in the injection-molding process, which is not achieved in the case of a large number of geometries. The invention relates to a method for adapting a component description of a workpiece to be produced with amorphous properties, which method comprises: —defining a cooling behaviour of at least a part of a workpiece to be produced, taking account of a component description of the workpiece; —adapting at least a part of the component description, taking account of the defined cooling behaviour of the workpiece.

The invention relates to a method for adapting a component description of a workpiece to be produced with amorphous properties, to a control method, to a computer-readable storage medium, to a device for adapting a component description and to a system for producing a workpiece.

Amorphous metals are a new class of materials which have physical properties or combinations of properties that cannot be realized in other materials.

The term “amorphous metals” refers to metal alloys that do not have a crystalline structure but an amorphous structure on the atomic level. The amorphous atomic arrangement that is unusual for metals results in unique combinations of physical properties. Amorphous metals are generally harder, more corrosion-resistant and stronger than conventional metals, and are at the same time highly elastic. There are thus no different surface potentials, so that no corrosion can arise.

Metallic glasses have been the subject of extensive research ever since they were discovered at the California Institute of Technology. Over the years, it has been possible to continuously improve the processability and the properties of this material class. While the first metallic glasses were still simple, binary alloys (composed of two components), the production of which required cooling rates in the range of 106 kelvin per second (K/s), newer, more complex alloys can be converted into the glassy state at significantly lower cooling rates in the range of a few K/s. This has a significant influence on process management and the workpieces that can be produced. The cooling rate, from which crystallization of the melt ceases to apply and the melt solidifies in the glassy state, is referred to as the critical cooling rate. The critical cooling rate is a system-specific variable which is strongly dependent on the composition of the melt and which moreover defines the maximum achievable component thicknesses. Considering that the thermal energy stored in the melt has to be removed quickly enough by the system, it is clear that only workpieces with a small thickness can be produced from systems with high critical cooling rates. At first, metallic glasses were therefore usually produced by melt spinning. In this case, the melt is stripped onto a rotating copper wheel and solidifies in a glass-like manner in the form of thin strips or films with thicknesses in the range of a few hundredths to tenths of a millimeter. As a result of the development of new, complex alloys with significantly lower critical cooling rates, it is increasingly possible to use other production methods. Today's solid glass-forming metallic alloys can already be converted into the glassy state by casting a melt into cooled copper molds. In this case, the realizable component thicknesses are in the range of a few millimeters to centimeters, depending on the alloy. Alloys of this kind are referred to as bulk metallic glasses (BMG). Nowadays, a large number of such alloy systems are known.

The classification of bulk metallic glasses usually takes place on the basis of their composition, wherein the alloying element having the highest proportion by weight is referred to as the base element. The existing systems comprise, for example, noble-metal-based alloys such as gold-, platinum-, and palladium-based bulk metallic glasses, early transition-metal-based alloys such as titanium- or zirconium-based bulk metallic glasses, late transition-metal-based systems based on copper, nickel or iron, but also systems based on rare earths, for example neodymium or terbium.

Bulk metallic glasses typically have the following properties compared to traditional crystalline metals:
higher specific strength, which enables, for example, thinner wall thicknesses,
higher hardness, whereby the surfaces can be particularly scratch-resistant,
much higher elastic stretchability and resilience,
thermoplastic formability and
higher corrosion resistance.

Due to their advantageous properties, such as high strength and the absence of solidification shrinkage, metallic glasses, in particular bulk metallic glasses, are very interesting construction materials which are suitable in principle for the production of components in series production methods such as injection molding, without further processing steps being mandatory after shaping. In order to prevent crystallization of the alloy during cooling from the melt, a critical cooling rate must be exceeded. However, the greater the volume of the melt, the slower the cooling of the melt (with otherwise unchanged conditions). If a certain sample thickness is exceeded, crystallization will occur before the alloy can solidify amorphously.

In addition to the excellent mechanical properties of metallic glasses, unique processing options also result from the glassy state. Thus, metallic glasses can be shaped not only by metallurgical melting processes, but also by thermoplastic molding at comparatively low temperatures in a manner analogous to thermoplastic plastics or silicate glasses. For this purpose, the metallic glass is first heated above the glass transition point to then behave like a highly viscous liquid which can be formed at relatively low forces. After forming, the material is again cooled below the glass transition temperature.

When processing amorphous metals, natural crystallization is prevented by rapid cooling (freezing in the molten state) of the melt so that the atoms lose their mobility before they can assume a crystal arrangement. Many properties of crystalline materials are influenced or determined by faults in the atomic structure, i.e., by so-called lattice defects (gaps, shifting, grain boundaries, phase boundaries, etc.).

As a result of the rapid cooling, the shrinkage of the material is reduced so that more precise component geometries can be achieved with amorphous metals. Plastic deformation only takes place with elongations above 2%. In comparison, crystalline metallic materials show irreversible deformation at significantly lower elongations (<0.5%). Moreover, the combination of high yield strength and high elastic elongation results in a high elastic energy storage capacity.

However, the thermal conductivity of the material used sets a physical limit to the cooling rate, since the heat contained in the component must be released to the environment via the surface. This leads to limitations in the manufacturability of components and in the applicability of production methods.

Various methods for producing workpieces from amorphous metals are known. It is possible, for example, to produce workpieces using additive manufacturing methods such as 3D printing. The amorphous properties of the workpiece can be ensured by adjusting the process parameters such as the scan speed, the energy of the laser beam or the pattern to be scanned.

One advantage of the additive manufacturing technique is that in principle any conceivable geometry can be realized. Furthermore, it may be advantageous that, in the case of additive manufacturing methods, no separate cooling process is necessary, since effective cooling can be ensured by the layer-by-layer production of the workpiece and by setting the size of the melt pool via the laser energy and scan path of the laser.

A disadvantage of additive manufacturing methods is the low build-up rates at the time of the application, especially for large-dimensioned workpieces. Furthermore, high-purity powder material must be used as the starting material for the additive manufacturing process. If impurities are present in the material, crystallization can occur at the locations of the impurities, resulting in non-amorphous metal, which can lead to a deterioration in the mechanical and chemical properties. It may be necessary to finish the surface of the workpiece due to the impurities, which is complicated. In addition, additive manufacturing always results in a certain roughness on the surface of the workpiece, so that in most cases it has to be finished by grinding or milling.

A further production possibility is injection molding. In this case, workpiece weights in the range of 80-100 g can be realized at the time of the application. The material to be used is usually heated within approximately 20 seconds to approximately 1050° C. by induction heating and is homogenized.

After heating, the molten material is pressed into a mold by means of a punch. It is important for the material properties that when the mold is completely filled with material, the material within the mold should have a temperature above the material melting point throughout. In order to achieve amorphous material properties, the liquid material within the mold must subsequently be cooled rapidly to below the glass transition temperature.

The possible geometries in injection molding are limited to wall thicknesses of 0.3-7.0 mm due to the cooling rate of the material. In the case of larger wall thicknesses, the cooling rate will be too low, so that crystalline structures form before the material has cooled to below the glass transition temperature. With smaller wall thicknesses, the material cools too quickly depending on the length to be filled and solidifies before the mold is completely filled.

To ensure in advance during the construction, dimensioning, selection of the alloy material, selection of the production method or the like that the amount of heat supplied to the material can be released sufficiently quickly to the environment, the cooling behavior can be simulated and analyzed.

EP3246831 describes, for example, a method and a system for providing accurate, scalable and predictive 3D printing simulations on a numerical basis. In this case, complex parts can be discretized into finite elements by independent and arbitrary crosslinking. Subsequently, the printing profile and the printing time can be simulated. The finite element model combines the component structure with tool path information by means of an intersection module. This enables a simulation of localized heating effects and the cooling capacity for each finite element at any one time.

EP3246831 describes, based on numerical methods, a scalable and predictive 3D printing simulation for the production of complex components, wherein primarily the printing profile, printing time and cooling capacity are simulated on the basis of localized heating effects. A manufacturability analysis of the component, in particular with respect to its molten state and subsequent cooling, is not carried out.

Furthermore, DE102006047806 discloses simulating a model of hot-forming a metal blank from a convertible steel material with the aid of the finite element method. With hot-forming simulation, not only are the mechanical and physical properties of the steel material to be formed taken into account, but material data which are incorporated into the method in the form of a time-temperature conversion dataset of the specific steel material are taken into account in the context of a complex thermo-mechanically coupled simulation. In this way, on the basis of the relevant phase composition, the determined temporary local mechanical property values can be transferred to a failure model for improving the component prognosis and for process optimization.

DE102006047806 thus describes a simulation method for modeling hot-forming of a metal blank from a convertible steel material with the aid of the finite element method. In this case, temporary local mechanical properties, for example the hardness and the physical properties of the metal plate during and after the end of the hot-forming simulation on the basis of the local and temporary phase composition of the steel material, are in the foreground.

Furthermore, EP0864991 discloses a method for establishing an amorphous region by means of computer simulation of a semiconductor device manufacturing process by determining the amorphous region based on a relationship of the impurity concentration at the interface between a crystal and the amorphous region.

EP0864991 describes a computer simulation for establishing amorphous sites, which is, however, carried out on the basis of a structural analysis. A thermal analysis for the entire component is not provided for.

In addition, WO2015097273 discloses a method for producing a component which is produced by melting and solidifying a partially crystalline thermoplastic polymer, wherein the use of the component determines the degree of crystallinity. The proposed method comprises the following steps:

i. determining the isothermal crystallization kinetics of the polymer in the form of a mathematical formula;
ii. using the equation obtained in step (i) to simulate the behavior of the polymer during performance of the production method;
iii. determining the conditions for implementing the production method by the simulation in step (ii) to obtain the intended degree of crystallinity; and
iv. producing the part by implementing the production method with the conditions determined in step (iii).

WO2015097273 thus describes a production method for producing a component with a defined degree of crystallinity. For this purpose, starting from the production parameters of a real specimen delivering the necessary properties, the production parameters of the component to be produced are determined by means of simulation. The flow and solidification are simulated.

Another example is known from WO2018182513, which describes a computer-implemented method for assessing geometric changes in an object to be produced by an additive manufacturing process, wherein during this additive manufacturing process a crystallizable material is converted from a powder to a bulk form and in the process the object is formed from the bulk form.

The method of WO2018182513 comprises:

i. providing a simulation domain comprising a finite element model of the object embedded into a simulated cake of the powder; wherein the finite element model comprises finite elements of the object and finite elements of the simulated cake of the powder;
ii. assigning thermal properties of the bulk crystal resinable material to each finite element of the object;
iii. assigning the thermal properties of the powder crystallizable material to each finite element of the simulated cake of the powder;
iv. assigning a simulated first temperature to each finite element;
v. performing a finite element analysis of the finite element model under a simulated cooling condition, wherein the simulated cooling condition comprises applying a simulated second temperature to at least one boundary of the simulation area, wherein the simulated second temperature is lower than the simulated first temperature;

In this case, the finite element analysis of WO2018182513 comprises the following:

i. determining a simulated crystalline volume fraction of the simulated bulk crystallizable material for each finite element of the object;
ii. determining a simulated thermal expansion coefficient for each finite element of the object as a function of the simulated crystalline volume fraction, the thermal expansion coefficient (<3˜4) of a crystalline phase of the crystallizable material, and the thermal expansion coefficient (c &) of an amorphous phase of the crystallizable material;
iii. performing the finite element analysis until an equilibrium state is reached.

WO2018182513 describes a computer-implemented method for assessing geometric changes in a component to be produced by an additive manufacturing process. Here, a crystallization-related change in volume is the focus.

The described disadvantages of the prior art give rise to the object of ensuring amorphous properties in workpieces.

The object is achieved by the subject matter of claims 1, 11, 12, 13 and 17.

The object is achieved in particular by a method for adapting a component description of a workpiece to be produced with amorphous properties, which method comprises:
determining a cooling behavior of at least a part of a workpiece to be produced, taking account of a component description of the workpiece, in particular a CAD model;
adapting at least a part of the component description, taking account of the determined cooling behavior of the workpiece.

The invention is based on the consideration that the amorphous properties of amorphous metals are determined substantially by the cooling of the liquid starting material. It is therefore advantageous if the cooling behavior of the starting material is determined and a component description is adapted taking account of the cooling behavior. The component description can be adapted such that amorphous properties are achieved.

As shown, the cooling behavior depends on the geometry of the workpiece to be produced. The component description can thus indicate the geometry of the workpiece to be produced, for example by means of a CAD model. Overall, it can thus be ensured that amorphous properties are achieved in a workpiece produced with the component description.

In one embodiment, the adaptation can comprise inserting at least one coolant description into the component description, wherein the coolant description can indicate a component.

Adaptation can be carried out in such a way that coolant is provided. Coolant can lead to increased energy dissipation from the workpiece to be produced. Thus, cooling of the liquid starting material can be accelerated so that amorphous properties are achieved in the workpiece to be produced. For example, it is envisaged that coolant can be arranged within the component geometry. Thus, either coolant can be arranged in regions where no material is provided, or material can be replaced by coolant. Overall, particularly efficient cooling during production of the workpiece is thus ensured, so that amorphous properties can be achieved. The coolant can be indicated by the coolant description. A coolant description can, for example, take the form of a CAD file.

In one embodiment, a/the at least one coolant can be designed as a molded body, in particular as a metal rod, preferably as a copper rod, and/or as a casing of a/the workpiece.

Different designs for coolant are therefore conceivable. Molded bodies or one or more metal rods can be arranged in the workpiece in particular such that at least some of the coolant contacts the surroundings of the workpiece. Thus, heat can be efficiently transported to the outside from the interior of the workpiece. A casing has the advantage that heat can be released to the surroundings via a larger surface, and that the heat transfer from the workpiece to the casing can take place more quickly or more efficiently compared to a heat transfer from the workpiece to the ambient air.

In one embodiment, the adaptation can comprise determining a material to be used.

It is also conceivable to determine, by means of the adaptation, a material to be used. The material can indicate a degree of purity, for example. Furthermore, the material to be used can be indicated by the component description. In one embodiment, adaptation can be performed taking account of the material.

In one embodiment, the method can comprise optimizing the component description, in particular using a finite element simulation and/or finite volume simulation of the workpiece, in particular using the component description.

The component description can be optimized. The component description can thus be optimized for predefined loading conditions. For example, the weight can be optimized without functional losses with respect to defined loading conditions occurring. By way of example, it can be determined whether certain regions of the component geometry of the workpiece require no or less material in order to comply with the loading conditions.

Accordingly, in one embodiment, the optimization of the component description can comprise calculating at least one loading condition of the workpiece.

In one embodiment, the optimization of the component description can comprise identifying at least one local geometry of the workpiece in the component description, wherein the local geometry can indicate a region of the component description in which material can be saved.

It is therefore also provided that a local geometry can be identified during optimization, wherein material can be saved in the region of the local geometry. Thus, lighter but nevertheless stable workpieces can be manufactured.

In this case, a/the local geometry can indicate at least one volume element. A volume element can be defined as a cuboid or tetrahedron. For example, the at least one volume element can be an element which is used in the context of a finite element simulation, finite volume simulation and/or optimization.

In one embodiment, the/an insertion of at least one coolant can be carried out at least in the region of a/the identified local geometry.

It is now possible for coolant to be arranged in a region in which no material is required for defined loading conditions. Thus, the workpiece can be formed in a sufficiently stable manner and it is also possible to achieve the desired amorphous properties.

The cooling behavior may indicate a cooling rate in one embodiment. In one embodiment, an amorphicity value can also be calculated from the cooling rate. In one embodiment, at least one material property of the workpiece can be determined from a calculated amorphicity value. The cooling behavior can further comprise an indication that a cooling rate is below a critical cooling rate and/or comprises an indication that predefined material properties are achieved in the workpiece. In one embodiment, the cooling behavior can be stored by a data structure, e.g., as an array, vector and/or object of an object-oriented programming language, which is used during the adaptation.

It is particularly advantageous if a cooling behavior is determined for the component description. It is thus possible to take account of the temperature behavior during the manufacturing process before the actual production of the workpiece. The cooling behavior can indicate a cooling rate, for example. The cooling rate can indicate a temperature profile. It is thus possible to determine how long it takes for the workpiece to be produced to cool to a target temperature.

The method can comprise simulating a/the cooling behavior for the workpiece, wherein the cooling behavior can indicate a cooling rate. By simulation, temperature profiles and/or time-dependent temperature fields can be determined. The cooling behavior can also be determined using a finite element simulation and/or finite volume simulation. Overall, precise temperature determination is possible, so that more accurate results can be achieved when adapting the component description.

In one embodiment, the simulation can comprise simulating the cooling rate from an initial temperature in the range of up to 150° C. below a material melting point of the material used, in particular 750° C. to 1200° C. for an alloy used by way of example, for example for a Zr-based alloy, to a target temperature in the range of −50° C. of the material-dependent glass transition temperature to the material-dependent glass transition temperature, in particular in the range of 350° C. to 450° C., for example 410° C. for a Zr-based alloy used by way of example.

In order to prevent the formation of crystalline structures, it is necessary to cool the material rapidly below a glass transition temperature which is approximately 410° C. for an Zr-based alloy used by way of example. It is thus advantageous if, when adapting the component description, it is possible to take account of how quickly cooling to a temperature below the glass transition temperature takes place.

In one embodiment, the component description can indicate a plurality of volume elements, wherein the cooling behavior can indicate a cooling rate for at least one volume element, in particular for each of the plurality of volume elements, as the volume cooling rate.

It is further provided in one embodiment that the cooling rate for each volume element is indicated individually. The local geometry can thus be determined very precisely, and the adaptation can be carried out taking account of the cooling behavior of the plurality of volume elements. Additionally or alternatively, in one embodiment, the cooling behavior can be specified for a local geometry. The cooling behavior of the local geometry can be indicated by a combination of the cooling behavior of the individual volume elements.

The size of the volume elements can also determine the resolution of the determination of the local geometry. The parameters of the volume elements can therefore be adapted in one embodiment to optimize the precision, or the resolution, of the local geometry.

In one embodiment, comparing a/the cooling rate to a critical cooling rate may be provided for, wherein the adaptation may be performed taking account of the comparison.

In one embodiment, the adaptation may be performed only when the comparison shows that the cooling rate is below the critical cooling rate for at least one volume element, for example.

It is therefore conceivable for adaptation to be carried out only if the cooling rate is below the critical cooling rate without adaptation. The critical cooling rate may indicate a cooling rate necessary to achieve amorphous properties. It can thus be ensured that adaptation is carried out only if no amorphous properties are achieved otherwise.

In one embodiment, the method can comprise a classification, in particular for at least one, preferably each, volume element, of a/the component description, particularly preferably using a classifier, as to whether the cooling rate is below the critical cooling rate for at least a part of the workpiece. In particular, in one embodiment, classification may be performed for each volume element of a component description.

Methods of machine learning can thus also be used to determine whether the cooling rate of a volume element is below or above the critical cooling rate.

In this case, classifiers such as, for example, support vector machines, artificial neural networks or algorithms such as nearest neighbor methods can be used. In this case, methods of reinforcement learning, supervised learning or unsupervised learning are possible.

In supervised learning methods, a classifier can first be trained with training data. In one embodiment, the method can comprise training a classifier with training data, wherein the training data can indicate a plurality of cooling profiles.

An advantage when using classifiers is that the execution can be carried out significantly faster than a simulation of the cooling behavior. This reduces CPU usage. It also allows for performing the method on mobile terminals, such as tablets or mobile telephones.

In one embodiment, the method can comprise calculating a probability which can indicate, in particular for at least one volume element of a/the component description, preferably for each volume element, particularly preferably using a regression system or a regression unit, whether the cooling rate is below the critical cooling rate for at least a part of the workpiece.

In the following, the terms regression unit and regression system are considered equivalent.

It is also possible to directly calculate different values using a regression system. The use of a regression system is also significantly faster than the simulation of the cooling behavior. A regression system can also approximate a non-linear behavior, as is the case in a cooling process. In particular, calculating a probability of whether the cooling rate is below the critical cooling rate for a volume element is advantageous.

It is possible in one embodiment that the adaptation is carried out only when, for at least one volume element, the probability of whether the cooling rate is below the critical cooling rate for the at least one volume element is above an adaptation threshold value, for example greater than or equal to 50%, greater than or equal to 60%, greater than or equal to 70%, greater than or equal to 80%, greater than or equal to 90%, greater than or equal to 95% or greater than or equal to 99%.

The regression system can further be designed to indicate a plurality of volume elements in which adaptation can be carried out. In this case, a plurality of coordinates can be output by the regression system. A coordinate can correspond to and/or be assigned to a volume element. It is thus possible in a very simple manner to determine how the component description has to be adapted. A regression system can be designed, for example, as an artificial neural network.

A three-dimensional tensor can serve as input for the artificial neural network of the regression system and/or the classifier, which tensor contains an indication at each coordinate as to whether or not material is present at that location. It is also possible for each coordinate of the tensor to be associated with a tuple which can comprise material information. Material information can comprise an indication whether material is present at the coordinate, an indication of which type of material is present, and/or material parameters. Material parameters can include: material elasticity and/or density.

The output of the artificial neural network of the regression system and/or of the classifier can be designed as a tuple.

The object is further achieved in particular by a control method, comprising
providing a component description that indicates a workpiece to be produced;
adapting the component description, in particular according to a method as has been described above;
controlling a production plant using the adapted component description to produce a workpiece.

It is therefore further provided for an adapted component description to be used directly by a production plant to produce a workpiece. A workpiece having amorphous properties can thus be produced reliably.

The object is further achieved in particular by a computer-readable storage medium which contains instructions that cause at least one processor to implement a method as described above when the method is executed by the at least one processor.

The object is further achieved in particular by a device for adapting a component description of a workpiece to be produced with amorphous properties, which device comprises:
at least one storage unit for storing at least one component description;
at least one cooling determination unit which is designed to determine a cooling behavior of at least a part of a workpiece to be produced, taking account of the at least one component description;
an adaptation unit which is designed to adapt at least a part of the component description, taking account of the determined cooling behavior.

In one embodiment, the adaptation unit can be designed to insert at least one coolant description into the component description, wherein the coolant description can indicate a coolant.

In one embodiment, a/the at least one coolant can be designed as a molded body, as a metal rod, in particular as a copper rod and/or as a casing of a/the workpiece.

In one embodiment, the adaptation unit can further be designed to determine a material to be used, wherein the adaptation unit can further be designed to perform the adaptation of the component description taking account of the material.

In one embodiment, the device can comprise an optimization unit which can be designed to optimize the component description, in particular using a finite element simulation and/or a finite volume simulation of the workpiece.

In one embodiment, the optimization unit can further be designed to calculate at least one loading condition of the workpiece as part of the optimization.

In one embodiment, the optimization unit can further be designed to identify at least one local geometry of the workpiece in the component description, wherein the local geometry can indicate a region of the workpiece in which material can be saved.

In one embodiment, a/the local geometry can indicate at least one volume element.

In one embodiment, the adaptation unit can be designed to carry out a/the insertion of at least one coolant in the region of a/the identified local geometry.

In one embodiment, the cooling behavior can indicate a cooling rate. In one embodiment, the determination unit can be designed to calculate an amorphicity value using the cooling rate. In one embodiment, the determining unit can further be designed to determine at least one material property using the amorphicity value. Furthermore, the cooling behavior can comprise an indication that the cooling rate is below a critical cooling rate and/or an indication that predefined material properties are achieved.

In one embodiment, the device can comprise a simulation unit which can be designed to implement the simulation step of the method described above. The simulation unit can thus be designed to simulate a/the cooling behavior for the workpiece, wherein the cooling behavior can indicate a cooling rate. Furthermore, the simulation unit can be designed to determine temperature profiles and/or time-dependent temperature fields.

In one embodiment, the simulation unit can be designed to simulate the simulation of the cooling rate from an initial temperature in the range of up to 150° C. below a material melting point of the material used, in particular 750° C. to 1200° C. for an alloy used by way of example, for example a Zr-based alloy, to a target temperature in the range of the, in particular material-dependent, glass transition temperature—50° C., in particular 410° C. for a Zr-based alloy used by way of example.

In one embodiment, the component description can indicate a plurality of volume elements, wherein the cooling behavior can indicate the cooling rate as a volume cooling rate for at least one volume element, in particular for each of the plurality of volume elements.

In one embodiment, the device can comprise a comparison unit that can be designed to compare a/the cooling rate to a critical cooling rate, wherein the adaptation unit can be designed to perform the adaptation taking account of the comparison.

In one embodiment, the adaptation unit can be designed to perform the adaptation only when the comparison shows for at least one volume element that the cooling rate is below the critical cooling rate.

In an execution unit, the device can comprise a classification unit which can be designed to determine, in particular for at least one, preferably for each volume element, of a/the component description, whether the cooling rate for at least a part of the workpiece is below the critical cooling rate.

In one embodiment, the device can comprise a regression unit which can be designed to calculate a probability which can indicate, in particular for at least one volume element, preferably each volume element, of a/the component description, whether the cooling rate for at least a part of the workpiece is below the critical cooling rate.

The object is further achieved in particular by a system for producing a workpiece, which system comprises:
a device for adapting a component description, in particular as has been described above;
an injection-molding device which is designed to produce a workpiece using a component description, in particular using an adapted component description.

In one embodiment, the system can comprise:
a chamber of the injection-molding device for receiving liquid material;
a punch which is designed to introduce liquid material into the chamber at a punch speed, wherein the punch speed is selected taking account of the component description.

With regard to the computer-readable storage medium, the device and the system, similar or identical advantages are obtained as have already been described in connection with the method and the control method.

It is provided that all aspects described with respect to the method can be combined with the device and/or the system. It is also provided that the actions/method steps described in connection with the device and the system can be combined with the described method.

The invention is explained in more detail below with reference to exemplary embodiments. In the drawings:

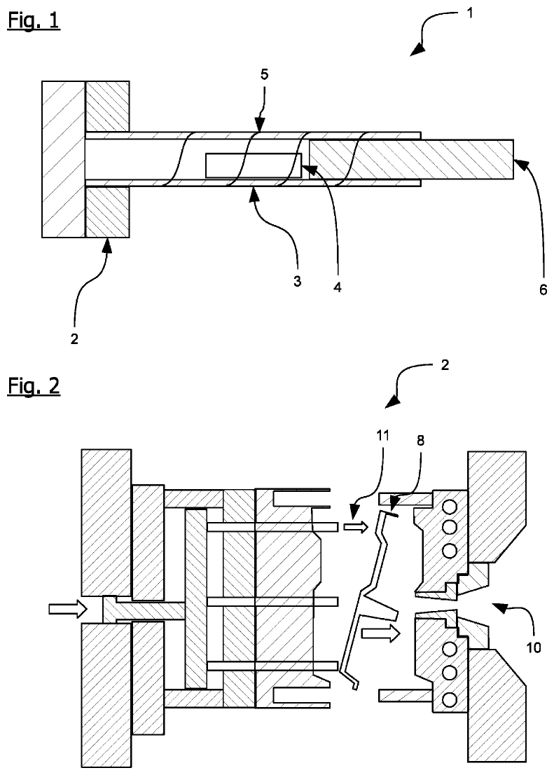

FIG. 1 shows a schematic illustration of an injection-molding machine;

FIG. 2 shows a schematic illustration of a tool;

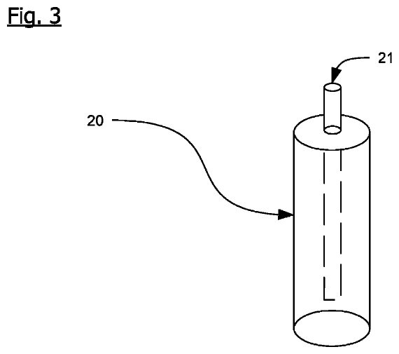

FIG. 3 shows a cross-section of a workpiece with a coolant;

FIG. 4 shows a temperature profile for a workpiece;

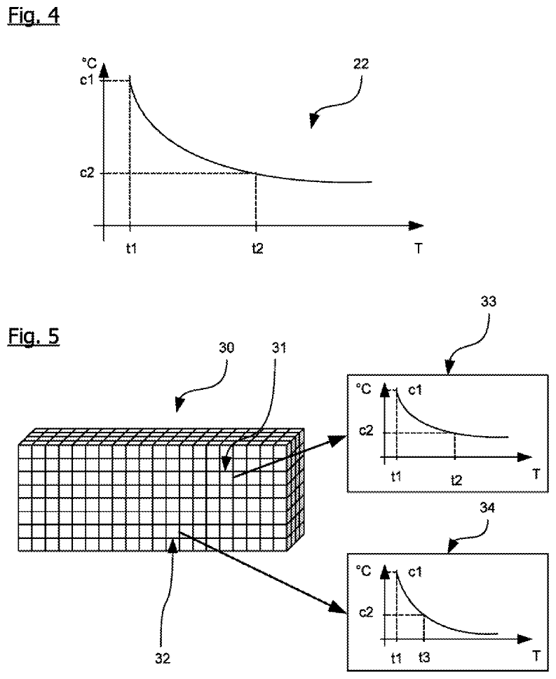

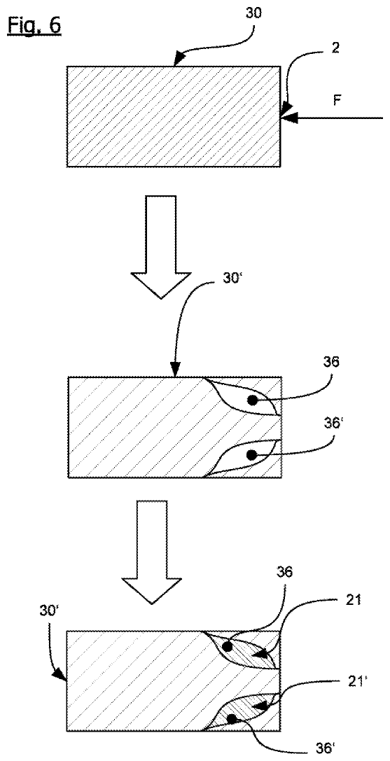

FIG. 5 shows an assignment of temperature profiles to volume elements of a component description;

FIG. 6 schematically shows the process of optimization and adaptation of a component description;

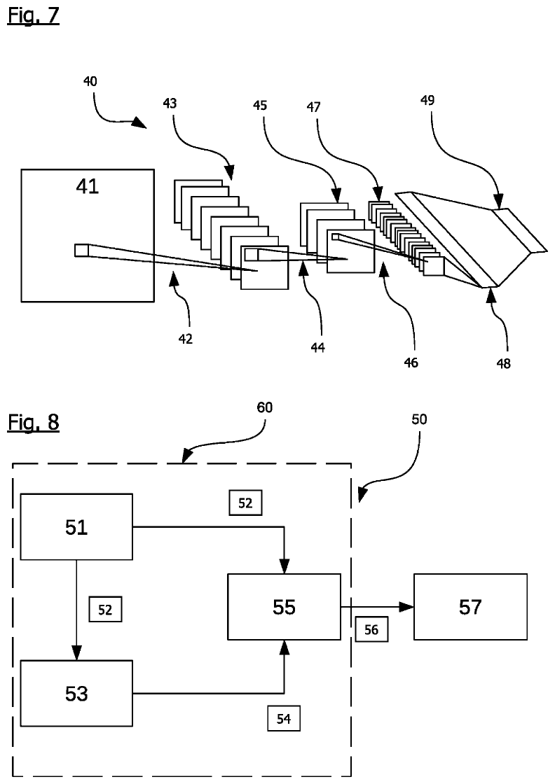

FIG. 7 shows the mode of operation of an artificial neural network;

FIG. 8 shows a first exemplary embodiment of a device for adapting a component description;

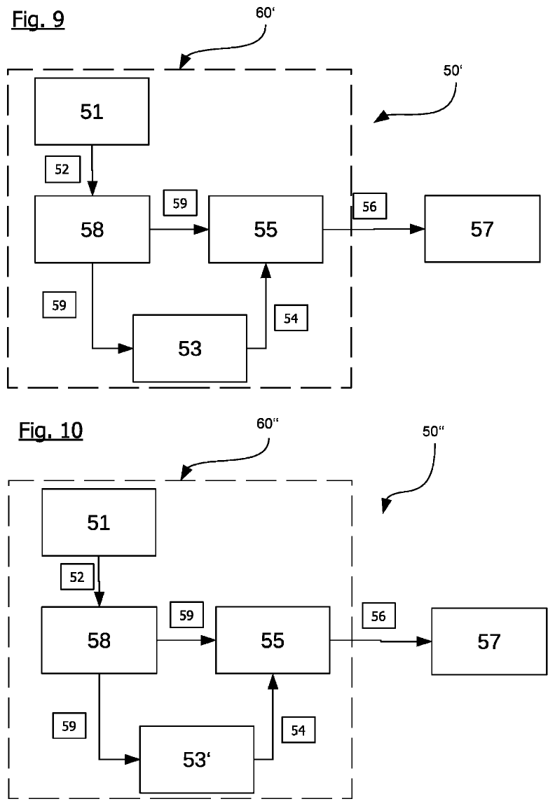

FIG. 9 shows a second exemplary embodiment of a device for adapting a component description;

FIG. 10 shows a third exemplary embodiment of a device for adapting a component description;

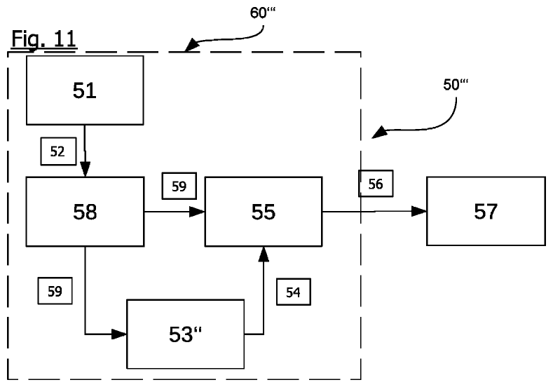

FIG. 11 shows a fourth exemplary embodiment of a device for adapting a component description.

In the following, the same reference numbers are used for identical parts or parts having the same effect.

FIG. 1 shows a schematic illustration of an amorphous metal (AMM) injection-molding system 1. The injection-molding system 1 comprises a mold in the tool 2 and a melting chamber 3. The melting chamber 3 is supplied with a solid alloy segment of an amorphously solidifying alloy (blank) 4 by a robot and is placed centrally in an induction coil 5. The blank 4 is heated within the melting chamber 3 by means of a heating element, in particular an induction field which is generated by the induction coil 5. The blank 4 is a solid alloy segment of an amorphously solidifying alloy. The alloy segment 4 comprises, for example, a certain amount of palladium, platinum, zirconium, titanium, copper, aluminum, magnesium, niobium, silicon and/or yttrium.

The blank 4 is melted by the heating element or the induction coil 5, so that it is present in molten form. Preferably, the blank 4 is heated to a temperature of 1050° C. The molten material is injected into the tool 2 by a piston 6.

FIG. 2 shows the schematic structure of an injection-molding tool. The molding chamber 11 is filled with a melt by means of one or a plurality of openings 10 leading into a molding chamber 11 of a tool 2. The molding chamber 11 is designed as a counterpart of the workpiece 8 to be produced. In the exemplary embodiment of FIG. 2, it is provided that an opening 10 can be used to guide liquid material into the molding chamber 11. It can be advantageous to use a plurality of sprues for filling the molding chamber 11 in order to achieve a uniform temperature distribution and to reduce turbulence of the melt. A uniform temperature distribution and a small number of turbulences lead to a better cooling operation, to homogeneous cooling and thus to uniform amorphous material properties.

The liquid material must rapidly cool down within the molding chamber 11 in order to prevent crystallization. The cooling of the liquid material depends greatly on the geometry of the component or workpiece 8 to be produced.

FIG. 3 shows an example component 20 which is a cylinder 20. The cooling process within the cylinder 20 takes more or less time depending on the size of the cylinder 20, i.e., on its height and diameter. At a critical size of the cylinder 20, cooling cannot be carried out rapidly enough to prevent crystallization of the material. This results in crystalline structures and not in the desired amorphous structures.

In order to obtain the desired amorphous structures, i.e., to prevent crystallization, the cooling rate in the inner region of the cylinder 20 must be high enough. This means that the cooling rate inside the cylinder 20 will be greater than a critical cooling rate. To accelerate cooling, coolants 21 can be arranged within a component 20 or a workpiece 8. For example, it is conceivable that molded parts 21 be arranged in the component 20 to be produced. In the example of FIG. 3, for example, a metal rod 21 is arranged and fastened within the cylinder 20. Due to the metal rod 21, melting heat can now be released both to the metal rod 21 and into the tool 2; the metal rod 21 thus ensures that a higher cooling rate can be achieved. Due to the possibility of injection-molding molded bodies 20 with high heat conduction, it is possible to also produce larger amorphous two-component components. The amorphous functional surfaces are designed such that they meet the mechanical, physical or chemical requirements. It is thus possible to prevent crystallization despite the size of the component 20.

FIG. 4 shows an example temperature profile 22. The exemplary embodiment of FIG. 4 relates to the inner part of the workpiece 20 of FIG. 3. As shown, the temperature falls from an initial temperature C1 at a time t1 to a temperature C2 reached at a time t2.

It is therefore possible to determine a cooling rate that indicates the drop in temperature, i.e., the temperature difference C1−C2, in the interval from t1 to t2. Furthermore, it is possible to determine whether the cooling rate is high enough to prevent crystallization. The cooling rate at which crystallization is prevented can be referred to as the critical cooling rate. In order to determine whether a component or workpiece to be produced will have amorphous properties, it is therefore possible to determine whether the cooling rate at each point of the workpiece is greater than the critical cooling rate.

Workpieces can be digitally described by a component description, for example by a CAD file. FIG. 5 shows, for example, a component description 30 of a cuboid, which component description is composed of a plurality of volume elements 31, 32. The component description 30 can therefore be, for example, a CAD model which is subdivided into individual volume elements 31, 32 by means of simulation software. The temperature behavior can now be simulated or predicted for each volume element 31, 32 of the component description 30.

FIG. 5 shows, for example, that a first temperature profile 33 is assigned to a first volume element 31. A second temperature profile 34 is assigned to a second volume element 32. The temperature profiles 33, 34 show the drop in temperature from an initial temperature C1 to a limit temperature C2. In an example of a zirconium-based amorphously solidifying alloy, the initial temperature is approximately 850° C. and the limit temperature is 410° C. The material 8 of the workpiece indicated by the component description 30 has approximately a temperature of 850° C. when it was injected into the mold 2. The glass transition temperature for the selected alloy is approximately 410° C. This means that no crystalline structure is adopted when a critical cooling rate, i.e., a rate above the critical cooling rate, is exceeded. Thus, if the material 8 is cooled down rapidly enough to the critical temperature, amorphous structures will be obtained. If the cooling rate is below the critical cooling rate, the melt will solidify in the crystalline state and not in the amorphous state.

As can be seen from FIG. 5, the limit temperature C2 is reached in the case of the first temperature profile 33 at a time t2. In the second temperature profile 34, the limit temperature C2 is reached at a time t3. As can be seen from the first and second temperature profiles 33, 34, time t3 is before time t2. This means that the temperature in the temperature profile 33, which is assigned to the first volume element 31, falls more slowly than in the second temperature profile 34, which is assigned to the second volume element 32. The cooling rate in the second temperature profile 34 is therefore greater than in the first temperature profile 33. Assuming that the cooling rate in the first temperature profile 33 is less than the critical cooling rate required for obtaining amorphous structures, the component description 30 will need to be adapted to convey the heat more quickly out of the workpiece 8, so that the cooling rate at the location of the first volume element 31 is greater than the critical cooling rate.

The temperature diagrams 33 and 34 can be generated using a simulation unit. This means that a simulation of the temperature behavior is carried out for each volume element 31, 32. It is thus possible to determine the temperature diagrams 33 and 34 very precisely. The results of the simulation unit can be provided digitally as cooling behavior, for example as an object in an object-oriented programming language. However, it is also possible for the cooling behavior to be provided as a text file or in any other format.

FIG. 6 shows an exemplary embodiment in which a component description 30 is optimized and in which coolants 21, 21′ are introduced into the component description 30 of a workpiece, so that the cooling rate is increased. The coolant 21, 21′ is indicated by a coolant description which can be a digital representation of the coolant 21, 21′, for example a CAD file.

In the exemplary embodiment of FIG. 6, a three-dimensional cuboid is described by the component description 30, wherein FIG. 6 is a lateral sectional view. A force vector F is plotted on the right-hand side of the workpiece or the associated component description 30 at a force application point 2. Using a material optimization method, it is now determined at which locations of the workpiece described by the component description 30 material can be saved. In this case, the material optimization is carried out taking account of the loading condition defined by the force vector F at the force application point 2.

As can further be seen from FIG. 6, the result of material optimization is an optimized component description 30′ for an optimized workpiece, which comprises empty spaces 36, 36′. Empty spaces 36, 36′ define a local geometry on which no material is necessary, so that the optimized workpiece produced with the component description 30 withstands the defined loading condition.

It is now provided that coolants 21, 21′ be arranged in the empty spaces 36, 36′ in order to improve the heat transport out of the workpiece. For example, the coolants 21, 21′ can be molded parts made of copper, which have good thermal conductivity. However, it is also possible to use other materials. In the exemplary embodiment shown, the empty spaces 36, 36′ are completely filled. It is also possible for at least the outer contour of the empty spaces 36, 36′ to be filled with a material which has sufficient thermal conductivity, such as copper.

In addition to a simulation for determining the temperature profiles of a workpiece or the volume elements 31, 32 of a component description 30, it is also possible to carry out a classification. It is thus possible to classify each volume element 31, 32 as to whether a cooling rate assigned to the respective volume element 31, 32 is greater than a critical cooling rate. It is thus possible to dispense with a simulation so that more efficient processing is possible. Such a classification can be carried out using a classifier or a classification unit. For example, so-called nearest neighbor methods, artificial neural networks or support vector machines can be used. These classifiers are trained with training data in a training phase. For a plurality of component descriptions and the respective volume elements contained, the training data contain information on whether the respective cooling rates of the volume elements are greater than a critical cooling rate. The critical cooling rate can be determined taking account of the material provided for the workpiece.

In addition to a classification, it is also possible to predict a cooling rate value using a regressor or a regression unit. A complicated simulation can thus also be dispensed with. Artificial neural networks can also be considered as regression units.

FIG. 7 shows an artificial neural network, which in the case of FIG. 7 is designed as a so-called convolutional neural network 40 (CNN 40). The neural network 40 of FIG. 7 can be designed as a classifier or as a regressor.

Input data 41 for the neural network 40 may be a tensor, i.e., a three-dimensional matrix, which has a plurality of data elements. Each data element can correspond to a volume element. Each data element can be designed as a tuple which indicates whether material is present at the location of the corresponding volume element, what material is used, and/or what initial temperature prevails at the location of the corresponding volume element.

A CCN is defined by a plurality of parameters. A kernel sequentially scans the input data in a first step. The so-called stride of the kernel indicates by how many volume elements the kernel must be shifted during each scan. The size of the kernel can also be defined. The stride and the size of the kernel thus define the so-called feature detectors 43 which are generated by a first convolution 42. Each feature detector 43 detects a specific feature in the input data. For example, a feature detector 43 may indicate whether or not material is present at a particular location. Overall, a plurality of feature detectors 43 are generated which have not been previously defined manually.

According to the same principle, a new set of feature generators 45 is generated from the first feature detectors 43 in a second convolution 44, wherein during the second convolution the number of feature generators is reduced compared to the first convolution. Such a step is referred to as pooling or subsampling.

A third set of feature generators 47 is generated in a third convolution 46. In the last step, a class is assigned to each volume element by means of a so-called soft-max layer. This means that it can be seen from the output whether the cooled speed for a volume element is greater or less than the critical cooling rate.

Each layer of the CCN 40 consists of a large number of neurons, i.e., of activation functions to which weights are assigned. The output of the neuron is activated or not activated depending on the weight and an input value. Possible activation functions include, for example, logit, arc tan, Gaussian functions. Training of the CCN 40 is performed using the back-propagation algorithm, wherein the values of the weights are determined.

There are a number of different models for CNN, such as VGG-net, RES-net, general adversiral networks or Google LeNet. Any of these implementations can be used, or another implementation is possible. Training of the neural networks can be carried out efficiently, since a plurality of the operations can be carried out parallelized. The inference, i.e., the querying of values for certain component description, can be carried out very efficiently.

FIGS. 8-11 show different exemplary embodiments of devices which implement the method steps described above.

For example, FIG. 8 shows a device 50 which is part of a system 60 and which comprises a storage unit 51. The storage unit 51 is designed to store a component description 52 which describes a workpiece. The device 50 further comprises a cooling determination unit 53, which is designed to determine a cooling behavior 54 using the component description 52. This means that the cooling determination unit 53 determines for volume elements of the component description 52 whether the cooling rate at the volume elements is greater than or less than a critical cooling rate.

The cooling behavior 54 is read in by an adaptation unit 55 which is also part of the device 50. Furthermore, the adaptation unit 55 reads the component description 52 from the storage unit 51. The adaptation unit 55 is designed to determine, taking account of the component description 52 and the cooling behavior 54, how the component description 52 or the workpiece described by the component description has to be changed so that the cooling rate of all volume elements of the component description 52 is greater than the critical cooling rate.

An adapted or optimized component description 56 is subsequently delivered to an injection-molding machine 57, which produces the workpiece or component according to the adapted component description 56. In particular, the component description 56 can also indicate information on the operation of the injection-molding machine 57. For example, the component description 56 can indicate an advance speed of the punch 6. It is also conceivable for the adapted component description 56 to indicate via how many inlet openings 10 the liquid material is to be inserted into a mold 2.

The exemplary embodiment of FIG. 9 corresponds substantially to the exemplary embodiment of FIG. 8. The exemplary embodiment of FIG. 9 shows a system 60′ comprising a device 50′, which also has a storage device 51, a cooling determination unit 53 and an adaptation unit 55. The system 60′ further comprises an injection molding machine 57. In addition, an optimization unit 58 is provided in the device 50′. The optimization unit 58 is designed to determine at least one local geometry on which material can be saved for a workpiece. Such a method is described, for example, in connection with FIG. 6.

The optimization unit 58 is designed to output an optimized component description 59 to the adaptation unit 55 and the cooling determination unit 53.

The exemplary embodiment of FIG. 10 corresponds substantially to the exemplary embodiments of FIGS. 8 and 9. FIG. 10 shows a system 60″ with a device 50″ which comprises a storage unit 51, an optimization unit 58 and an adaptation unit 55. The system 60″ further comprises an injection-molding machine 57.

In the exemplary embodiment of FIG. 10, it is provided that the optimized component description 59 generated by the optimization unit 58 is read in by a simulation unit 53′. The simulation unit 53′ is designed to simulate a cooling behavior or a cooling rate for each volume element of a component description 59. The result of the simulation is read in as cooling behavior 54 by the adaptation unit 55, which is designed to generate an adapted component description 56, taking account of the cooling behavior 54 and the optimized component description 59. The adapted component description 46 is read in by the injection molding machine 57 and used to produce a workpiece or component.

FIG. 11 shows a further exemplary embodiment which shows a system 60′″ with a device 50″. The device 50″ comprises a storage unit 51, an optimization unit 58 and an adaptation unit 55. The system 60″ further comprises an injection-molding machine 57. The device 50″ moreover comprises an AI system 53′″ which is designed to implement a classifier and/or a regressor, as have been described in connection with FIG. 7.

The AI system 53″ generates a cooling behavior 54 which can be used by the adaptation unit 55 together with the optimized component description 59 in order to generate an adapted component description 56 which is used by the injection molding machine 57 in order to produce a workpiece or component.

### LIST OF REFERENCE SIGNS

1, 57 Injection-molding machine
2 Mold
3 Melt cylinder
4, 4′ Heating element
5 Filler hopper
6 Screw
7 Punch
8 Liquid starting material
9 Conduit system
10, 10′, 10″, 10′″ Inlet opening
11 Molding chamber
20 Workpiece
21, 21′ Coolant/copper rod
22 Temperature profile
30 Component description/CAD model
30′ Optimized component description
31 First volume element
32 Second volume element
33 First temperature diagram
34 Second temperature diagram
35 Force application point
36, 36′ Empty space
40 Artificial neural network
41 Input data/tensor
42 First convolution
43 Feature detector
44 Subsampling
45 Second feature detectors
46 Second convolution
47 Third feature detectors
48 Feedforward layer
49 Output layer
50, 50′, 50″, 50′″ System
51 Storage unit
52 Component description/CAD model
53 Cooling determination unit
53′ Simulation unit
53″ AI system
54 Cooling behavior
55 Adaptation unit
56 Adapted component description
58 Optimization unit
59 Optimized component description
60, 60′, 60″, 60′″ Device
C1 Initial temperature
C2 Target temperature
T1, T2 Time
F Force

1. A method for adapting a component description of a workpiece to be produced with amorphous properties, which method comprises:
determining a cooling behavior of at least a part of a workpiece to be produced, taking account of a component description of the workpiece; and,
adapting at least a part of the component description, taking account of the determined cooling behavior of the workpiece.

2. The method according to claim 1, wherein
the adaptation comprises inserting at least one coolant description into the component description, wherein the coolant description indicates a coolant.

3. The method according to claim 1, wherein
the adaptation comprises determining a material to be used, wherein the adaptation is performed taking account of the material.

4. The method according to claim 1, wherein
optimizing the component description, in particular using a finite element and/or finite volume simulation of the workpiece.

5. The method according to claim 4, wherein
the optimization of the component description comprises identifying at least one local geometry of the workpiece in the component description, wherein the local geometry indicates a region of the workpiece in which material can be saved.

6. The method according to claim 5, wherein
the determination of the cooling behavior comprises simulating a cooling behavior for the workpiece, wherein the cooling behavior indicates a cooling rate.

7. The method according to claim 4, wherein
the component description indicates a plurality of volume elements, wherein the cooling behavior indicates a volume cooling rate for at least one volume element, in particular for each of the plurality of volume elements.

8. The method according to claim 1, wherein
comparing a cooling rate to a critical cooling rate, wherein the adaptation is performed taking account of the comparison.

9. The method according to claim 1, wherein
the adaptation is performed only when the comparison shows that the cooling rate is below the critical cooling rate for at least one volume element.

10. The method according to claim 1, wherein
classification, in particular for at least one, preferably each, volume element, of a component description, particularly preferably using a classifier, as to whether the cooling rate is below the critical cooling rate for at least a part of the workpiece.

11. A control method, comprising
providing a component description that indicates a workpiece to be produced;
adapting the component description, in particular in accordance with the method according to claim 1; and,
controlling a production plant using the adapted component description to produce a workpiece.

12. A computer readable storage medium containing instructions that cause at least one processor to implement a method according to claim 1 when the method is executed by the at least one processor.

13. A device for adapting a component description of a workpiece to be produced with amorphous properties, which device comprises:
at least one storage unit for storing at least one component description;
at least one cooling determination unit which is designed to determine a cooling behavior of at least a part of a workpiece to be produced, taking account of the at least one component description; and,
an adaptation unit which is designed to adapt at least a part of the component description taking account of the determined cooling behavior.

14. The device according to claim 13, wherein
the adaptation unit is further designed to determine a material to be used, wherein the adaptation unit is further designed to perform the adaptation of the component description taking account of the material.

15. The device according to claim 13, wherein
an optimization unit is further designed to identify at least one local geometry of the workpiece in the component description, wherein the local geometry indicates a region of the workpiece in which material can be saved.

16. The device according to claim 13, wherein
a comparison unit that is designed to compare a cooling rate to a critical cooling rate, wherein the adaptation unit is designed to perform the adaptation taking account of the comparison.

17. A system for producing a workpiece, which system comprises:
a device for adapting a component description, in particular according to claim 13; and,
an injection-molding device which is designed to produce a workpiece using a component description, in particular using an adapted component description.

18. The system according to claim 17, wherein
a chamber of the injection-molding device for receiving liquid material; and,
a punch which is designed to introduce liquid material into the chamber at a punch speed, wherein the punch speed is selected taking account of the component description.
